(19) United States
(12) Patent Application Publication
(10) Pub. No.: US 2020/0039381 A1
(43) Pub. Date: Feb. 6, 2020

(54) LOWER SEAT ASSEMBLY FOR A VEHICLE SEAT

(71) Applicant: IEE INTERNATIONAL ELECTRONICS & ENGINEERING S.A., Echternach (LU)

(72) Inventors: Ingrid SCHECKENBACH, Ferschweiler (DE); Oleg ZEILER, Igel (DE); Guenter GOEDERT, Trier (DE); Andrej MATTHEIS, Igel (DE); Jan MARCINCIN, Vranovnad Toplou (SK)

(21) Appl. No.: 16/496,051

(22) PCT Filed: Mar. 23, 2018
(86) PCT No.: PCT/EP2018/057423

§ 371 Date: Sep. 20, 2019

(30) Foreign Application Priority Data
Mar. 23, 2017 (LU) 100 147

(51) Int. Cl. B60N 2/00; G01G 19/414; G01G 19/08; B60N 2/70; B60R 21/015

(52) U.S. Cl. CPC B60N 2/002; G01G 19/4142; B60N 2002/0268; B60N 2/7035; B60R 21/015; G01G 19/08

(57) ABSTRACT

Lower seat assembly for a vehicle seat, including a compressible cushion, with an upper face for supporting a seat occupant, and a lower face, such that the cushion is compressed when a load is applied on the upper face by an occupant. The lower seat assembly further includes a cushion supporting element, disposed below the cushion for supporting the cushion, and at least one sensing device comprising a proximity sensor, configured to sense a distance to a proximity sensor target facing the sensor. Either the sensor or the target is fixed to the lower face of the cushion, and the other one is fixed to the cushion supporting element. The lower face bends when the cushion is compressed and generates a relative movement between the sensor and the target, and the sensing device is configured to derive a weight class of an occupant from the distance between the sensor and the target.

### TECHNICAL FIELD

The present invention relates generally to a lower seat assembly e.g. of a vehicle seat. The present invention relates more particularly to a lower seat assembly for a vehicle seat configured for detecting an occupancy state.

### BACKGROUND OF THE INVENTION

Vehicle seats in the automotive field are made to accommodate the occupant but have also an important role in the safety of the vehicle occupants. When seated inside a vehicle, an occupant is surrounded by complex safety means that may be triggered in case of an accident or a particular event. In an automobile the most common physical safety means around a seat occupant are the seatbelt and the airbag system.

Triggering these safety means correctly is an important matter. As it is the case for airbags systems, they can only be triggered once before requiring replacement, and replacement of airbags is very costly. It is therefore desired that airbags be triggered only when necessary. For example an airbag should not be activated when there is no occupant on the seat. There are also situations when an airbag should not be activated for safety reasons, like for example when the seat is occupied by a rearward facing child seat.

In modern vehicles, seats are equipped with additional sensors that will help safety systems in determining whether and how they should be activated. These sensors are for instance configured to determine occupancy of the seat or more precisely to determine the nature and stature of the occupant. They are preferably installed in the lower seat part of the vehicle seat which is the part on top of which an occupant sits.

It is already common to use various sensor types in a vehicle seat with different advantages and drawbacks. For example, capacitive sensors are a reliable and cost effective way in order to determine occupancy of a seat. Such sensors are commonly located inside or below the supporting cushion of the lower seat. Capacitive sensors are efficient to determine the presence or absence of a human body on top of the seat, but their main drawback is that their result is independent of the weight of the occupant and they are therefore only capable of making the difference between an empty seat and a person, irrespective of the person's size.

For a more efficient airbag deployment strategy, there should be a more precise occupancy sensing system. For example, it is now important to distinguish between a small person and a child or a child seat. According to the criteria applied in the automotive domain, there is a need for a sensor that is capable of distinguishing a vehicle seat occupant between 5% female versus 50% male. In addition a separation between the 5% female from 3 and 6 year old children is an additional benefit. Such a sensor could further be used in combination with a capacitive sensor for greater measurement results.

There are already systems known in the art that are capable of determining whether a 5% female or a 50% male occupies the seat, like for example in document US 2005/0218886 A1.

This document discloses a vehicle occupant sensing system for a vehicle seat. The system comprises a sensor assembly located on the lower face of the cushion of the seat. The sensor assembly comprises a housing with a base and an upper slide member. The base member holds a Hall Effect sensor and the upper slide member comprises a magnet or sensor target. The assembly further comprises a biasing member adapted to bias the upper slide member away from the base member. When an occupant seats on the seat, the pressure exerted on the cushion brings the upper slide member toward the base member against the bias of the biasing member and the sensor is configured to derive the weight of the occupant from the distance between the upper slide member and the base member.

The sensor described in the above document is capable of determining the weight or at least a weight class of the occupant, and is resistant against shear forces that may occur inside the cushion.

Nevertheless, the different parts such as the upper slide member, the base member and the biasing member are always in contact with one another, resulting in many frictions between the parts of the assembly. The frictions constitute a loss of force that impairs the precision of the measurements of the sensor. Moreover these frictions may become relevant over time and reduce the robustness of the system in a critical way. Also, the system disclosed in the above document requires a large assembly space below the seat cushion that will become a constraint when used in combination with other sensor or security systems.

### SUMMARY

It is therefore desirable to provide a solution for a lower seat assembly comprising a system for detecting an occupancy state that improves the solutions disclosed in the state of the art, and particularly that is efficient and allows possibilities of combinations with more sensor systems.

In at least some embodiments, the invention overcomes at least some of the above discussed deficiencies and disadvantages by providing a lower seat assembly for a vehicle seat, comprising a compressible cushion with an upper face for supporting a seat occupant. The cushion is made of a compressible material such that the cushion is compressed when a load is applied on the upper face by an occupant. The lower seat assembly further comprises at least one sensing device comprising a proximity sensor and a proximity sensor target, the proximity sensor being configured to sense a distance to the proximity sensor target facing the proximity sensor in a substantially vertical direction.

At least one of the proximity sensor or the proximity sensor target is fixed generally to the cushion.

The configuration is such that a compression of the cushion generates a relative movement between the proximity sensor and the proximity sensor target, and the sensing device is configured to derive a signal indicative of an occupancy, e.g. a occupant present/not present signal or a weight class of an occupant, from said relative movement and/or the distance between the proximity sensor and the proximity sensor target.

The lower seat assembly comprises a compressible cushion that is provided to improve the comfort of the occupant. There is no need for an additional base plate or a large element to support the elements of the sensor. This is advantageous if the assembly is used in combination with one or more other sensing devices like for example a capacitive sensor. As explained before, capacitive sensors are very efficient in order to detect the presence of a body but they are not capable of determining a weight class of the occupant. The possibility of using the present lower seat assembly in combination with another sensing device is another advantage of this seat assembly construction.

When an occupant is supported by the cushion, the weight of the occupant applies a load generally directed vertically to the seat cushion supporting structure or the vehicle floor. The load compresses the cushion and reduces the distance between the proximity sensor and the proximity sensor target. As the load is relative to the weight of the occupant; the distance between the sensor and the target of the sensing device is also related to the weight of the occupant.

Another advantage is that there is no additional component needed to connect the sensor and the sensor target, thus eliminating frictions during the relative movements of the sensor and the sensor target.

Advantageously, the lower seat assembly may comprise a plurality of sensing devices in order to determine a signal indicative of an occupancy or measure the weight class of the occupant in different location of the seat. A plurality of sensing devices may provide a more precise weight classification of the occupant.

In a basic embodiment, the sensing device generates a signal indicative of the presence or absence of an occupant on the seat. Such an embodiment may e.g. be used in an application like seat belt reminders. In other preferred embodiments, the signal indicative of an occupancy may be a weight class of an occupant, so that the sensing device may be used in occupancy classification systems.

By determining the relative movement between the sensor and the target, the sensing device is able to determine a weight class of the occupant. The weight class of the occupant allows determining a person's category at least between a 5% female and a 50% male occupant.

In preferred embodiments of the invention, the proximity sensor is configured to emit an analog signal. The analog signal may e.g. be the raw signal before processing. Using the analog signal of the sensor makes it easy to calibrate the sensor. The signal sent when there is no occupant becomes the reference and the weight class of the occupant is determined based on that reference. The calibration of the sensing device may be made once during installation of the sensor, or the calibration may be made regularly, like for example during maintenance operation. If the sensor is used in combination with another sensor like for example a capacitive sensor, the information of occupancy of the other sensor may be used to trigger more recurring calibration procedure, for example when starting the vehicle.

In embodiments, the cushion comprises a lower face, and the proximity sensor or the proximity sensor target is fixed to the lower face of the cushion. In the description we may also refer to the upper face of the cushion as the A-surface and to the lower face of the cushion as the B-surface. The sensing device is therefore preferably located on the B-surface of the cushion in order have a minimum impact on the comfort.

Fixing the proximity sensor or the proximity sensor target directly to the B-surface may improve the sensation of comfort for the occupant, and does not require a large assembly space below the cushion.

In embodiments, the lower face of the cushion comprises a recess and the proximity sensor and/or the proximity sensor target is lodged inside the recess.

The recess provides a longer distance between the sensor and the target when there is no load applied on the cushion by an occupant. The relative movement of the sensor and the target is measured on a longer distance, resulting in a more precise measurement. The recess is advantageous if the cushion is soft and the bending of the B-surface important. The recess is also advantageous when the cushion supporting element is uniformly in contact with the cushion, as there would be a very narrow leeway for the movement of a sensing device component fixed to the B-surface toward a sensing device component fixed to the cushion supporting element.

In embodiments, the lower seat assembly comprises a cushion supporting element arranged below the cushion for supporting the cushion; and one of the proximity sensor or the proximity sensor target is fixed to the cushion supporting element.

The cushion supporting element does not bend when an occupant is seated, or the bending of the supporting element is relatively very low in comparison to the compression of the cushion. It results that when the cushion is compressed the sensor and the target of the sensing device are moved closer toward each other, and vice versa. Setting a component of the sensing device outside of the cushion may ease accessibility for maintenance or installation of the sensing device.

In embodiments, the proximity sensor is an inductive sensor. Preferably the cushion supporting element comprises a spring, and the spring is the proximity sensor target of the sensing device.

In these embodiments of the invention, the sensing device uses a common cushion supporting element made of a horizontal spring pattern as target for the sensor. As the springs are usually made of metal, they are conveniently used in combination with an inductive sensor. These embodiments propose a reduction of the variety of the components by using an existing part of the cushion supporting element as target of the sensor. There is also a gain of assembly space which is advantageous when the assembly is used in combination with one or more other sensors.

In other embodiments of the invention, the proximity sensor is a Hall Effect sensor and the proximity sensor target is a magnet. The Hall Effect sensor is efficient to measure a distance to a magnet target, even if another conductive element is in the surrounding of the sensor. The Hall Effect sensor may be preferred in embodiments for its particular features as known by a skilled person.

In embodiments, the proximity sensor and the proximity sensor target are inserted in the cushion during a seat molding process.

In these embodiments, the sensing device is embedded inside the seat cushion. The sensing device may be partly inserted during the seat cushion molding process providing a quick assembly procedure, and a good comfort for the occupant. Moreover, the sensing device uses almost no space outside of the seat cushion, allowing a greater combination with other sensing devices that may be disposed for example below or on the B-surface of the cushion.

Advantageously, the sensing device comprises a connecting cable, or a connector, in order to connect the sensing device to a processing unit or another device.

In embodiments of the invention, the lower seat assembly further comprises a temperature compensation system. The person skilled in the art will know that temperature can be an important constraint on the precision and/or the reliability of sensing devices. The temperature compensation system allows the system to recalibrate the sensor according to a measured change of temperature of the system. This provides more robustness against changes of temperature. The temperature compensation system is particularly advantageous in combination with an automatic calibration system as described above.

The invention also provides a method for calibration of the proximity sensor of a lower seat assembly. The method comprises the step of configuring seat assembly tolerances during a manufacturing or installation process of the lower seat assembly.

The method removes a constraint of precision in the assembly process. Indeed, the sensor does not need to be positioned at a precise distance from the target as only the variation of distance is relevant. Calibration is made after the positioning of the sensor and takes into account the real distance between the sensor and the sensor target as a reference.

### BRIEF DESCRIPTION OF THE DRAWINGS

Further details and advantages of the present invention will be apparent from the following detailed description of not limiting embodiments with reference to the attached drawing, wherein:

FIG. 1 is a schematic cross-sectional side view of a part of one embodiment of a lower seat assembly for a vehicle seat,

FIG. 2 is a schematic view of one embodiment of a sensing device 16 of the lower seat assembly of FIG. 1,

FIG. 3 is a schematic cross-sectional side view of a part of one other embodiment of a lower seat assembly for a vehicle seat,

FIG. 4 is a schematic top view of one preferred embodiment of a cushion supporting element of the lower seat assembly of FIG. 3,

FIG. 5 is a schematic cross-sectional side view of a part of another embodiment of a lower seat assembly for a vehicle seat, and

FIG. 6 is a schematic cross-sectional side view of a part of yet another embodiment of a lower seat assembly for a vehicle seat.

### DESCRIPTION OF THE ILLUSTRATED EMBODIMENTS

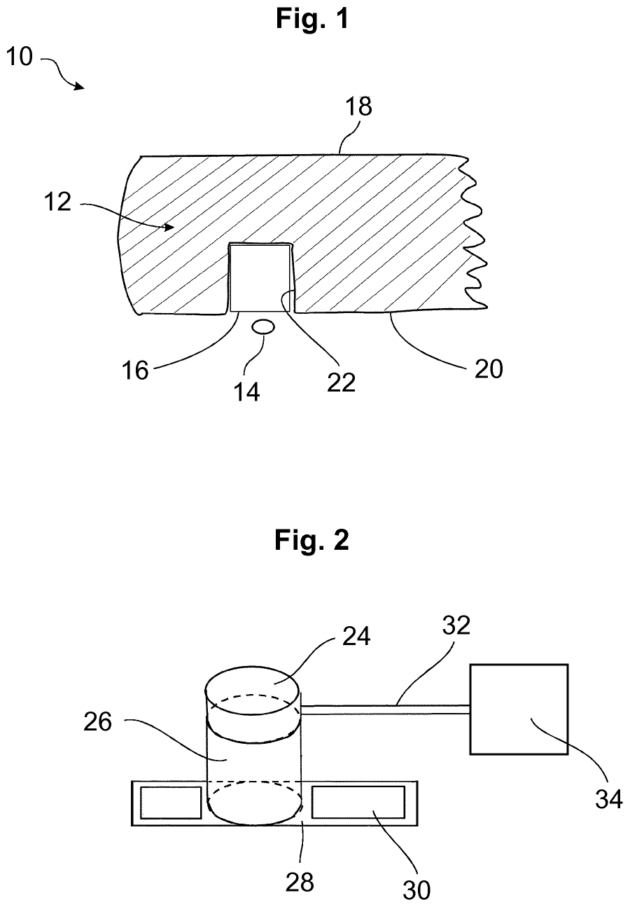

As illustrated in FIG. 1 the lower seat assembly 10 for a vehicle seat according to one embodiment of the invention comprises a compressible cushion 12, a cushion supporting element 14, and a sensing device 16. In FIG. 1, only a part of the compressible cushion 12 is represented to highlight various features. It is to be understood that the features that are not shown in FIG. 1 may be deemed identical to the features shown in FIG. 1.

The compressible cushion 12 is a common cushion as used in vehicle seats. It may be filled with foam or any compressible material capable of retrieving its original shape when no force is applied on it.

Here the compressible cushion 12 comprises a substantially plane upper face 18, also called A-surface, and a substantially plane lower face 20, also called B-surface. The upper face 18 is the face supporting a seat occupant and substantially facing upward, while the lower face 20 is facing in the opposite direction below the cushion 12.

The cushion 12 is supported on the cushion supporting element 14 through its lower face 20. The contact between the lower face 20 and the cushion supporting element 14 depends on the shape of the supporting element 14. Here the supporting element 14 comprises a plurality of horizontal springs, one of which is shown in FIG. 1 with the same numeral reference 14.

The lower face 20 of the cushion comprises a recess 22 in which is lodged one element of the sensing device 16. The recess 22 is located on the lower face 20, vertically above the spring 14 when the cushion 12 is placed on the supporting element 14.

FIG. 2 shows a schematic view of one embodiment of a sensing device 16 of the lower seat assembly 10. In this embodiment, the sensing device 16 comprises an inductive sensor 24 lodged in the recess 22, and the sensor target is the spring 14 of the cushion supporting element. The inductive sensor 24 is configured to sense a distance to the vertically facing sensor target, in this embodiment the spring 14.

When an occupant is seated on the cushion 12, the cushion is compressed. The compression of the cushion causes the lower face 20 to bend down toward the outside of the cushion 12 and consequently toward the spring 14. The compression of the cushion 12 through the bending of the lower face 20 generates a relative movement between the inductive sensor 24 in the recess 22, and the spring 14. The movement implies a change of the distance between the sensor 24 and the spring 14 which is measured by the sensor 24. The sensing device 16 is further configured to derive a weight class of the occupant from the distance between the sensor 24 and the target 14.

FIG. 2 further shows a detail of the inductive sensor 24 assembly inside the recess 22. The inductive sensor 24 is mounted on top of a compressible part 26, e.g. a compressible foam part in the form of a cylinder, which is fixed on a piece of textile 28. Advantageously, the inductive sensor 24 and the compressible part 26 are filling the recess 22 such that they are not able to move inside the recess 22, while the piece of textile 28 maintains the sensor 24 and the compressible part 26 inside de recess 22.

The piece of textile 28 comprises two adhesive surfaces 30 that are covered with adhesive material configured to fix the piece of textile 28 against the lower face 20 of the cushion 12.

Advantageously, the piece of textile is fixed to the lower face 20, outside of the recess 22 and flush with the lower face 20 of the cushion, such that the piece of textile closes the recess 22 holding the sensor 24 and the compressible part 26 still inside the recess 22. Such an assembly is thus easy to mount/dismount for the technician, and it also only occupies the space inside the recess 22 leaving free assembly space in order to, for example, mount another sensor assembly that will be used in combination with the inductive sensor 24.

In embodiments not shown, the inductive sensor 24 is connected to the compressible part 26 by, for example, glue or adhesive material, or any other suitable means. It may also be only deposited on top of the compressible part 26 and held in position inside the recess 22 by complementarity of shapes. The inductive sensor 24 may further be fixed to the recess 22 for example with adhesive material.

The compressible part 26 is compressed when the lower face 20 of the cushion 12 is bent towards the supporting element 14 as explained above. One role of the compressible part 26 is to protect the sensor in case the bending of the lower face pushes the sensor 24 all the way into contact with the spring 14. The compressible part 26 would avoid any damage to the sensor 24.

It is important that the bias of the compressible part 26 against the sensor 24 and the piece of textile is minimal, and advantageously low in comparison with the bias of the cushion 12 against a seating occupant. A strong bias of the compressible part 26 would provoke a premature wear of the piece of textile 28. The bias of the compressible area would also act against the movement of the sensor 24 along with the lower face 20 and reduce the amplitude of the change of the distance between the sensor 24 and the target 14, resulting in a lower precision of the measurement.

The person skilled in the art will notice that the forces induced by an occupant seating on the seat are not purely vertical and may comprise shear forces. Consequently, the compression of the cushion inducing a bending of the lower face of the seat will move the sensor in a vertical direction but will also imply horizontal movement of the sensor. Advantageously, the sensing device is located close to the center of the lower face where the shear forces are less present. Furthermore, it should be understood that the horizontal movement of the sensor is short enough to still allow the sensor to sense the target.

The sensor 24 further comprises a connection cable 32 for connecting the sensor 24 to a processing unit 34. The processing unit 34 may be located outside of the cushion at any location that is the most convenient according to the general assembly of the lower seat.

The sensor 24 preferably transmits an analog signal to the processing unit 34 that is indicative of the distance between the sensor 24 and the spring 14. The analog signal may be further processed in order to determine a weight class of the occupant.

Along with the information about the change of the distance between the sensor and the target, it might be also important to sense that dynamic behavior of the target relative to the sensor. That dynamic behavior might also be used to better determine the nature of the seat occupant.

The weight classes comprise at least a light person, defined as 5% of an average female, and a heavy person, defined as 50% of an average male. Advantageously, the weight classes comprise more classes as for example a 3 year old child, and a 6 year old child. If the lower seat assembly 10 is associated with for example an airbag system, a more precise weight class may be used in order to control the degree of inflation and the strength of the propulsion of the airbag in case of accident. That would produce a more appropriate reaction of the security system and better protection results.

In FIG. 1, only one sensing device is shown, but it is understood that a plurality of sensors may be arranged in a plurality of recesses in the lower face 20 of the cushion 12. The signals sent by the plurality of sensors may then be processed together in order to mitigate a weight class estimation.

The analog signal sent by the sensor 24 may be used in order to calibrate the sensor 24. The amplitude of the signal when no occupant is seated defines the reference of the distance between the sensor 24 and the target 14. Other seat tolerances may be used to calibrate the sensor 24, like for example the maximal compression of the cushion. In operation, only the variation of the distance and consequently of the amplitude of the signal needs to be measured. It is thus easy to calibrate the sensor 24 and modify its reference after the wear of the cushion or to change the sensibility of the sensor.

In a preferred method for calibration of the proximity sensor, the lower seat assembly is for example first installed into the seat, and then the seat tolerances are calibrated.

The calibration may also be made automatically by the processing unit 34. As explained above, the processing unit 34 may use information from another sensor used in combination with the present sensor, like for example a capacitive sensor, in order to perform calibration when the seat is unoccupied.

In embodiments, not shown, the lower seat assembly further comprises a temperature compensation system. As temperature conditions may affect the precision of proximity sensors, the temperature compensation is configured to sense the temperature in the environment of the sensor, and in case the temperature crosses a predetermined threshold, the system sends a request to the processing unit to perform a calibration of the sensor.

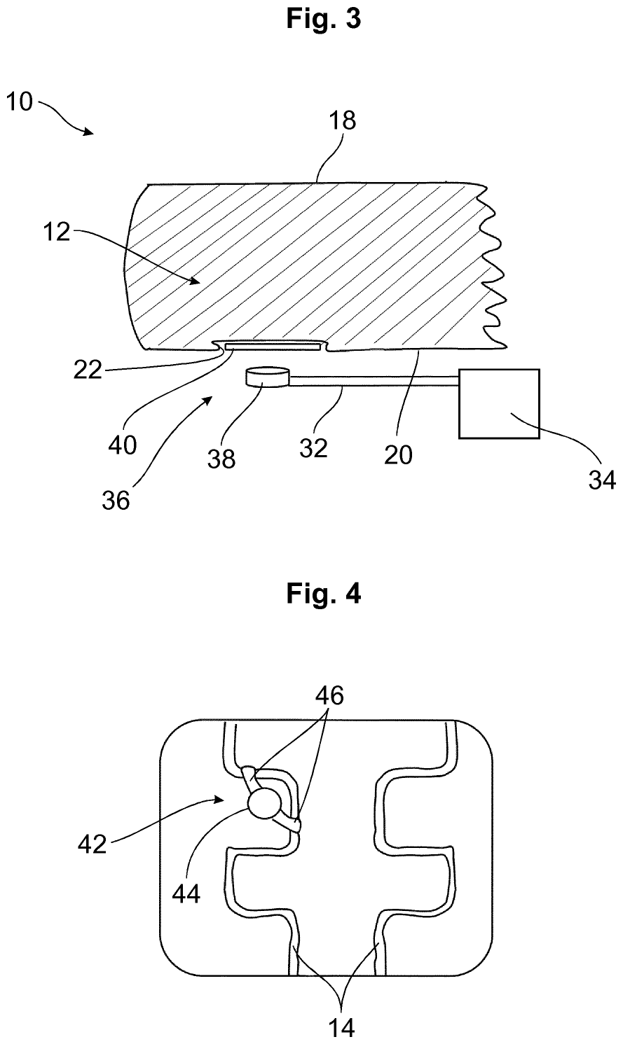

FIGS. 3 and 4, FIG. 5, and FIG. 6 show other examples of embodiments of the lower seat assembly according to the invention. These embodiments will be described in comparison with the embodiments described above. Accordingly, the features that will not be described in these embodiments can be deemed identical as the ones described above. Furthermore, characteristics that remain the same as in the embodiments described above will be referred to using the same numeral references.

FIGS. 3 and 4 show the same embodiment of the invention. In FIGS. 3 and 4, the lower seat assembly 10 comprises a compressible cushion 12 with an upper face 18 and a lower face 20. The lower face 20 of the cushion 12 comprises a recess 22. The lower seat assembly 10 further comprises a cushion supporting element 14 for supporting the cushion and a sensing device 36.

In this embodiment of the invention, the sensing device 36 comprises a Hall Effect sensor 38 and a magnet 40 that constitutes the Hall Effect sensor target.

The magnet 40 is received in the recess 22. The magnet 40 is fixed in the recess 22 by any suitable fixation means like for example using adhesive material. Fixing the magnet 40 on the lower face 20 of the cushion 12 is here an easier assembly task as in the above embodiments as the magnet 40 is only one simple solid component and it is easy to manipulate.

The sensor 38 is positioned in front of the magnet 40 and fixed to the cushion supporting element 14. The cushion supporting element 14 is shown at FIG. 14 as a pair of horizontal springs 14. In this embodiment, the cushion supporting element 14 further comprises a sensor support 42. The sensor support 42 is made of one supporting plate 44 configured to receive the sensor 38. Advantageously the supporting plate 44 comprises means, not shown, in order to hold the sensor in position. The means may be for example a clamping system, screws or any suitable means known in the art.

The sensor support 42 further comprises two connecting arms 46 fixed to the supporting plate 44. The connecting arms 46 are configured to connect the supporting plate 44 to the cushion supporting element 14. The connecting arms 46 are advantageously adapted to the particular shape of the springs 14 so that when the cushion 12 is supported by the spring 14, the sensor 38 fixed to the supporting plate 44 is facing the magnet 40. Advantageously, the sensor support may be used to adapt the distance between the sensor 38 and the target 40.

The sensor 38 also comprises a connecting cable 32 to connect it to a processing unit 34. The sensor 38 provides an analog signal with the similar advantages as in the previous embodiments.

In this embodiment, the lower seat assembly is very light in assembly space required. The signal transmitted by the sensor is easy to calibrate and may be used in combination with a temperature compensation system.

Hall Effect sensors have the advantage to detect the position of a magnetic target regardless of the presence of nearby conductive elements. Therefore, if the cushion supporting element is a plate, a large metallic spring or a spring made out of a non-conductive material, Hall Effect sensors will be preferred to inductive sensors.

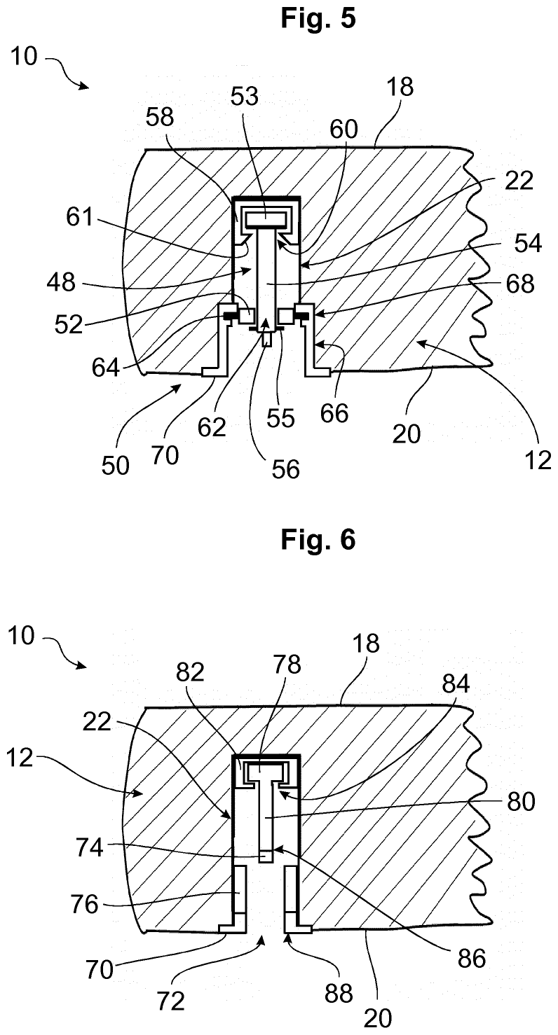

Another example of embodiments of the invention is shown in FIG. 5. Here the lower seat assembly 10 also comprises a compressible cushion 12 with an upper face 18 and a lower face 20. The lower face 20 of the cushion 12 comprises a recess 22. A sensing device 48 is lodged in the recess 22.

In this embodiment of the invention, the sensing device 48 has a generally cylindrical shape. FIG. 5 is a cross-sectional side view through the axis of the cylinder of the sensing device 48.

The sensing device 48 comprises e.g. a Hall Effect sensor 50 and an annular magnet 52 that constitutes the Hall Effect sensor target.

The Hall Effect sensor 50 comprises a cylindrical sensor head 53, a cylindrical guiding rod 54 and a connector 56. The sensor head 53 is the actual proximity sensor. It is held inside the recess by a sensor head receiver 58.

The sensor head receiver 58 is here a part preferably made out of plastic material. The sensor head receiver 58 is complementary to the bottom of the recess 22. Connection between the sensor head receiver 58 and the recess 22 is made by any suitable means like for example adhesive material.

The sensor head receiver 58 comprises a round opening 60 to let the sensor head 53 in. The opening 60 is here slightly smaller than the size of the sensor head 53. The opening 60 comprises a slanted rim 61 increasing the size of the opening 60 towards the exterior of the receiver 58. Hence, during installation, the sensor head 53 is pushed inside the sensor head receiver 58 through the opening 60 that is configured to be elastically deformed. As a result, the sensor head 53 is clipped into the receiver 58.

The guiding rod 54 comprises a relatively long cylinder of smaller diameter as the sensor head 53. The guiding rod comprises a first end fixed to the sensor head 53, and a second end 62 free. With the sensor head 53 held in the receiver 58, the guiding rod 54 extends vertically through the opening 60 of the receiver 58 inside the recess 22. The guiding rod 54 passes through the center of the annular magnet 52.

The second end 62 of guiding rod 54 comprises an abutment 55 configured to keep the guiding rod 62 from translating out of the annular magnet 52.

The second end 62 of the guiding rod 54 further comprises the connector 56. The connector 56 is connected to the sensor head 53 through a cable, not shown, passing inside the guiding rod 54. The connector 56 may further be connected to an external device or a processing unit. The sensor 50 provides an analog signal with the similar advantages as in the previous embodiments.

The center of the annular magnet 52 has a diameter configured to guide the guiding rod 54 in vertical translation. The annular magnet 52 further comprises a fixation ring 64 fixed to the outer diameter of the annular magnet 52. The fixation ring 64 is further fixed to a supporting cylinder 66.

The supporting cylinder 66 is configured to hold the annular magnet 52 in position inside the recess 22. The supporting cylinder 66 comprises a clamping area 68 complementary to the fixation ring 64 of the annular magnet 52. Fixation between the annular magnet 52 and the supporting cylinder 66 is here realized by complementary of forms. The supporting cylinder 66 is preferably made of plastic material. The fixation ring 64 of the magnet 52 is clipped into the clamping area 68.

The supporting cylinder 66 is fixed to walls of the recess 22. Fixation between the supporting cylinder 66 and the recess 22 may be made by any suitable means like for example adhesive material, clamping or tightening.

The supporting cylinder 66 further comprises an abutment 70 to block the cylinder 66 against a lower face 20 of the cushion 12 and forbid a vertical translation of the supporting cylinder inside the recess 22.

When the cushion 12 is compressed under the weight of an occupant, the sensor head receiver 58 and the sensor head 53 is moved downward toward the annular magnet 52. The guiding rod 54 keeps the movement of the sensor head substantially vertical without creating too much friction. Sensing of the occupancy is then identical as in the embodiments above.

In another embodiment shown in FIG. 6, the lower seat assembly 10 also comprises a compressible cushion 12 with an upper face 18 and a lower face 20. The lower face 20 of the cushion 12 comprises a recess 22. A sensing device 72 is lodged in the recess 22.

The sensing device 72 has a generally cylindrical shape. FIG. 6 is a cross-sectional side view through the axis of the cylinder of the sensing device 72.

Comparably to the embodiment shown in FIG. 5, the sensing device 72 comprises a Hall Effect sensor 74 and an annular magnet 76 that constitutes the Hall Effect sensor target. The Hall Effect sensor 74 comprises a cylindrical head 78, and a cylindrical guiding rod 80.

The head 78 is held inside the recess 22 by a head receiver 82. The head 78 is held inside the head receiver 82 by clipping it through an opening 84 of the receiver 82.

The guiding rod 80 comprises a relatively long cylinder of smaller diameter as the head 78. The guiding rod 80 comprises a first end fixed to the head 78, and a second end 86 free. With the head 78 held in the receiver 82, the guiding rod 80 extends vertically inside the recess 22. The guiding rod 80 is configured to pass freely through the center of the annular magnet 76.

The second end 86 of the guiding rod 80 comprises the actual proximity sensor.

The annular magnet 76 is fixed inside the recess 22 by a supporting cylinder 88. The annular magnet 76 is here stacked on top of the supporting cylinder 88. Connection between the annular magnet 76 and the supporting cylinder 88 may be realized by any suitable means like for example adhesive material.

In other embodiments, not shown, a plurality of annular magnets is stacked on top of the supporting cylinder in order to amplify the magnetic field in the center of the magnets. This plurality of stacked annular magnets also results in the hall signal being different depending on the position of the sensor 74 within the stack of annular magnets.

The supporting cylinder 88 is fixed to walls of the recess 22. Fixation between the supporting cylinder 88 and the recess 22 may be made by any suitable means like for example adhesive material, clamping or tightening.

The supporting cylinder 88 further comprises an abutment 70 to block the cylinder 66 against a lower face 20 of the cushion 12 and forbid a vertical translation of the supporting cylinder inside the recess 22.

The sensor 74 may communicate with an external device or a processing unit through a wireless transmitter located in the cylindrical head.

When the cushion 12 is compressed under the weight of an occupant, the head 78 of the sensing device 72 is moved downward toward the annular magnet 76 and finally through the center of the annular magnet 76. Sensing of the occupancy is then identical as in the embodiments above.

In this embodiment, both the sensor and the sensor target are mounted inside a recess of the cushion. The space below the cushion is entirely free and can be used to mount other devices.

1. Lower seat assembly for a vehicle seat, comprising:
a cushion with an upper face for supporting a seat occupant, said cushion being made of a compressible material such that the cushion is compressed when a load is applied on the upper face by an occupant;
at least one sensing device comprising a proximity sensor and a proximity sensor target, the proximity sensor being configured to sense a distance to said proximity sensor target facing the proximity sensor in a substantially vertical direction;
wherein at least one of the proximity sensor or the proximity sensor target is fixed generally to the cushion; wherein the compression of the cushion generates a relative movement between the proximity sensor and the proximity sensor target; and
wherein the sensing device is configured to derive a signal indicative of an occupancy from said relative movement and/or the distance between the proximity sensor and the proximity sensor target.

2. Lower seat assembly according to claim 1, wherein said signal indicative of an occupancy is a weight class of an occupant.

3. Lower seat assembly according to claim 1, wherein the proximity sensor is configured to emit an analog signal.

4. Lower seat assembly according to claim 1, wherein the cushion comprises a lower face, and the proximity sensor or the proximity sensor target is fixed to the lower face of the cushion.

5. Lower seat assembly according to claim 1, wherein the cushion comprises a lower face, wherein the lower face of the cushion comprises a recess and wherein the proximity sensor and/or the proximity sensor target is lodged inside the recess.

6. Lower seat assembly according to claim 1, further comprising a cushion supporting element arranged below the cushion for supporting the cushion, wherein one of the proximity sensor or the proximity sensor target is fixed to the cushion supporting element.

7. Lower seat assembly according to claim 1, wherein the proximity sensor is an inductive sensor.

8. Lower seat assembly according to claim 6, wherein the cushion supporting element comprises a spring, and wherein the spring is the proximity sensor target of the sensing device.

9. Lower seat assembly according to claim 1, wherein the proximity sensor is a Hall Effect sensor and the proximity sensor target is a magnet.

10. Lower seat assembly according to claim 1, wherein the proximity sensor and the proximity sensor target are inserted in the cushion during a seat molding process.

11. Lower seat assembly according to claim 1, further comprising a cable or a connector, for connecting the proximity sensor to a processing unit or another device.

12. Lower seat assembly according to claim 1, further comprising a temperature compensation system.
